(19) United States
(12) Patent Application Publication
(10) Pub. No.: US 2008/0137526 A1
(43) Pub. Date: Jun. 12, 2008

(54) Systems and methods for achieving reduced inter-sector pilot interference in a mobile communication system

(75) Inventors: Zhucheng Jiang, Kunshan City (CN); Haitao Wang, Shanghai (CN)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/651,237

(22) Filed: Jan. 9, 2007

(30) Foreign Application Priority Data
Dec. 8, 2006 (CN) 200610162067.0

(51) Int. Cl. H04J 11/00

(52) U.S. Cl. 370/209; 370/208

(57) ABSTRACT

The pilots of a wireless system are arranged to reduce inter-sector interference by establishing a systematic assignment of pilots across the system. In one embodiment, the pilots are differently coded and directionally positioned within a cell such that the same pilot from adjacent cells do not overlap. In one embodiment, Walsh codes are used to create the differently coded pilot signals.

### RELATED APPLICATIONS

This application is related to and claims priority to Chinese Application No. 200610162067.0 filed Dec. 8, 2006 entitled “SYSTEMS AND METHODS FOR ACHIEVING REDUCED INTER-SECTOR PILOT INTERFERENCE IN A MOBILE COMMUNICATION SYSTEM”, the disclosure of which is hereby incorporated herein by reference.

### TECHNICAL FIELD

This invention relates to wireless cellular systems and more particularly to wireless systems for arranging a cellular network so as to reduce the interference from pilot communications both within each cell and between cells.

### BACKGROUND OF THE INVENTION

Wireless communications rely on transmissions (air interfaces) between a transmission point and a number of mobile communication devices that are located at various locations with respect to the transmission point. These air interfaces include: single carrier; Orthogonal Frequency Division Multiplexing (OFDM); Orthogonal Frequency Division Multiple Access (OFDMA); Wideband Code Division Multiple Access (WCDMA); and Universal Mobile Telecommunications System (UMTS). The OFDM and OFDMA interfaces are now often used in broadband wireless networks (WiMAX) that are based on the IEEE 802.16 standard. Scalable OFDMA (sOFDMA), and Flash OFDM, are also now either being considered or actually being used in some networks. For purposes of discussion herein, these air interface systems will be called modulation schemes.

As the number of simultaneous communication connections increases so does the probability of interference between the connections. Various frequency reuse schemes have been used over the years with one of the most popular being to divide a physical area into cells (usually, but not always) with a single transmission point at the center of each cell. The transmission point is typically divided into sectors with each sector pointed in a different direction. Various modulation schemes are employed to be sure that transmission in each sector does not interfere with each other. Within a sector, different channels and/or modulation is used to prevent interference between mobile devices in that sector. The frequency reuse pattern between cells is selected so as to reduce the probability of interference across sectors.

Some air interface systems use a “pilot” signal between the transmission point and a potential connection to a wireless device so as to establish certain parameters with respect to the upcoming connection. These parameters can be, for example, power level, channel number timing information, etc. Currently, these pilot signals are selected for a given transmission point on an “as available” basis and broadcast from the transmission point or points. All mobile devices must monitor all pilot frequencies or channels in order to be able to know how to communicate with any particular transmission point. Again, as transmission traffic increases so does the probability of interference among pilots from adjacent cells or sectors.

### BRIEF SUMMARY OF THE INVENTION

The pilots of a wireless system are arranged to reduce inter-sector interference by establishing a systematic assignment of pilots across the system. In one embodiment, the pilots are differently coded and directionally positioned within a cell such that the same pilot from adjacent cells do not overlap. In one embodiment, Walsh codes are used to modulate pilot signals.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment of pilot assignments to reduce interference; and

FIG. 2 is a chart showing one embodiment of differentiating the pilot codes using a Walsh code of length four.

### DETAILED DESCRIPTION OF THE INVENTION

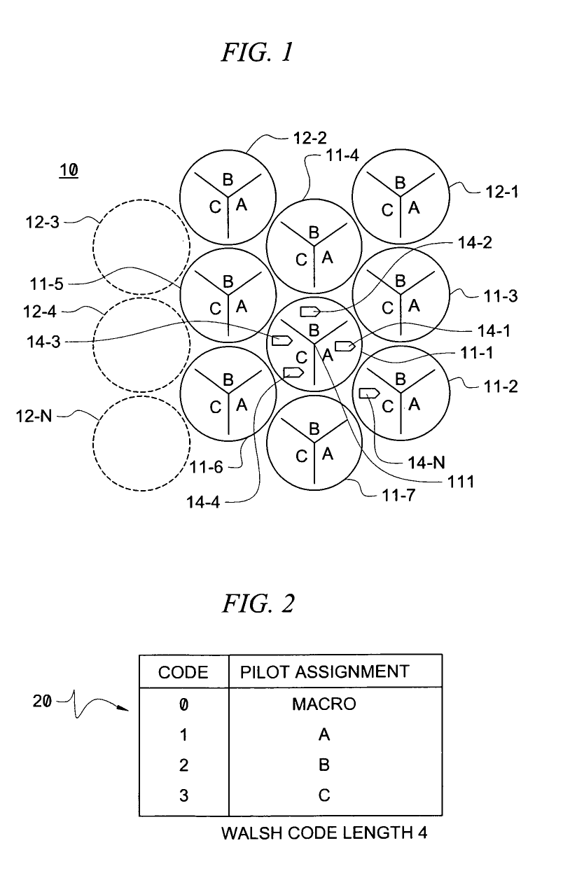

FIG. 1 illustrates one embodiment of pilot assignments to reduce interference. As shown, wireless network 10 consists of a plurality of wireless transmission points, such as transmission point 111 shown at the center of cell area 11-1. Each of the other cell areas, such as cell areas 11-2 through 11-7 and 12-1 through 12-N, also have one or more transmission points (not shown). Communications connections are made between mobile devices, such as devices 14-1 through 14-N, and the transmission point in the cell serving the mobile device at any point in time. Note that while a single transmission point is shown in a cell there can, and often are, multiple transmission points serving one or more sectors of a cell.

For each cell in the embodiment of FIG. 1, such as cell 11-1, the pilot code which otherwise would be available though an air interface to any mobile device within transmission range is divided into three differentiated pilot codes. These three codes are used to form pilot sectors A, B, and C. The pilot sectors from all adjacent cell areas are set up so that the pilot frequency (or channel) used for a first sector is not the same as a for an adjacent second sector into which the pilot from the first sector can penetrate.

For example, the A sector of cell 11-1 “faces” the C sector (and possibly the B sector) of cell 11-2. Likewise the A sector of cell 11-1 faces the C sector of cell 11-3 and faces the B sector of cell 11-7. While it is possible that pilot signals from outlying cells could be the same as one of the pilots in cell 11-1, the relative signal strength between them should eliminate interference.

In one embodiment, a Walsh coding technique can be used to create the differentiation between the pilot codes. Walsh codes, which is also known as “Walsh-Hadamard codes,” are generated by an algorithm that establishes statistically unique sets of numbers for encrypting modulation signals. Known as “pseudo-random noise codes,” Walsh codes are “orthogonal” mathematical codes and as such, if two Walsh coded frequencies (signals) are correlated, the result is intelligible only if the signals are coded using the same Walsh code. As a result, a Walsh-encoded signal appears as random noise to a mobile terminal, unless that terminal uses the same code as the one used to encode the incoming signal.

FIG. 2 shows chart 20 based on a Walsh code of length 4 yielding four possible code sequences called 0, 1, 2, 3. Code 1 can be used, for example, to generate the A pilot, code 2 can be used to generate the B pilot and code 3 can be used to generate the C pilot. Walsh codes of even longer length can be used and if desired the different codes that come from a longer Walsh code can be used to reduce the repeating of codes in adjacent cells. Thus, for example, code 1 can be used for the A pilot in sectors 11-1 and 11-4 while code 5 (assuming a Walsh code of length 7) can be used for pilot A in cells 12-1 and 12-2.

Walsh codes of longer length, such as length 8 or 16, may also be used. Walsh codes of length 8 yield 7 usable code sequences, with 0 reserved for macro cell use. Longer sequences may reduce the inter-sector interference even further, since the reused code may be further away than with a shorter code. However, such a benefit has a trade-off. Longer Walsh codes decrease system tolerance to channel impairment. Further, mixed lengths of Walsh codes may be used, as well as adaptive lengths, based on planning needs or channel conditions. Changing a Walsh code, though, may require informing the mobile devices of the change.

In operation, each mobile device would be equipped with a list of Walsh codes so that as the mobile device passes in proximity to a transmission point (or points) the pilots from the various possible transmission points in the vicinity of the mobile device are received by the mobile device. The mobile device then can select which transmission point it will communicate with based on criterion established by the various cells or network. The pilots for each cell would contain information relevant to that cell and thus the information contained in the pilots for different cells will contain different information which will then be used by the mobile device to establish and maintain a proper air interface between the device and the proper transmission point.

In many situations, the mobile device will receive several different pilots, such that, for example mobile device 14-1 positioned in cell 11-1 may “see” pilot signals from many cells, such as from cells 11-1 (pilot A), 11-3 (pilot B, C) and 11-2 (pilot C). Since the A, B, and C pilots are differentiated (in this embodiment by the orthogonal Walsh coding technique) the mobile device can “listen” to each pilot without interference from the other pilots even though the device is receiving multiple pilots and even if the pilots are close enough to the same strength that interference would occur but for the differentiated coding.

Note that while the Band C pilots from multiple cells, such as from cells 11-2 and 11-3 might be broadest in the direction of device 14-1, interference is mitigated by the use of different coding between pilot A versus pilot C and between pilot A versus pilot B. The same situation prevails with respect to any device in any sector of network 10. The A pilot from remote cells, such as from cell 12-2, even if it did extend to mobile device 14-1, would be so diminished in strength as to not cause any interference with the A pilot from cell 11-1. If desired, a Walsh coding using more codes can be used such that the next nearest cell can have different coding from its neighbors.

If desired, one of the codes, for example the zero code, can be used as the pilot of a macro cell that fills in gaps in coverage between regular cells. Thus, the zero coded pilot can be made available across the entire network or only in selected locations that are known to have poor coverage under the differentiated scheme as discussed above.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A wireless communication network having a plurality of individual cells, in which wireless communications can be established between at least one transmission point in any one cell and a plurality of mobile devices, said network comprising:
a set of pilot signals in each cell, each pilot signal coded in a different manner and said pilot signal set repeating in each said cell; and
wherein each said pilot signal of a pilot signal set is positioned in said cells so as to broadcast in a direction different from each of the other pilot signals in said cell, and wherein said broadcast direction is such so as not to cover the same physical area as a similarly coded pilot signal from an adjacent cell.

2. The network of claim 1 in which said pilot signals are coded orthogonal to each other.

3. The network of claim 2 wherein said coding is Walsh coding.

4. The network of claim 2 wherein said coding produces at least four distinct codes and wherein each said set of pilot signals broadcasts in three distinct directional sectors, with each sector using a distinct one of said codes.

5. The network of claim 4 further comprising:
means for using a fourth one of said codes to fill coverage gaps between said sectors.

6. The network of claim 3 wherein the pilot signal set for adjacent sectors use the same set of codes in corresponding broadest directions.

7. A wireless network comprising:
at least one cell for communicating with mobile devices within the transmission range of said cell;
a set of pilot signals, said set of pilot signals coded so to be orthogonal to each other; and
at least one transmission point for broadcasting said set of pilot signals so that each pilot signal of said set of pilot signals is broadcast in a different direction.

8. The wireless network of claim 7 wherein said coding is Walsh coding.

9. The wireless network of claim 8 wherein said Walsh coding is length four and wherein said set of pilot signals contains three pilot signals.

10. The wireless network of claim 7 further comprising:
at least one pilot signal orthogonal to said set of pilot signals, said last-mentioned pilot signal broadcast without regard to said directional limitation.

11. The method of decreasing transmission interference of pilot signals in a wireless network, said method comprising:
establishing at least three different pilot signals for use by mobile stations for establishing communication connections with a transmission point; and
using a different one of said established pilot signals for transmission in a unique sector of said wireless network.

12. The method of claim 11 wherein said wireless network is divided into cells and wherein each said cell contains three differentiated pilot signals, said method further comprising:
positioning said sectors in each said cell such that pilot transmissions using a particular pilot code differentiated in a first manner in one cell do not interfere with pilot transmissions using a pilot code differentiated in the same first manner in an adjacent cell.

13. The method of claim 11 further comprising:
establishing at least one additional different pilot signal, said additional pilot signal used to fill gaps in pilot signal coverage in said networks.

14. The method of claim 11 wherein said different pilot codes are achieved by modifying the pilot signals using Walsh codes.

15. The method of claim 11 wherein said different pilot codes are achieved by modifying the pilot signals using orthogonal coding techniques.

16. The method of establishing a wireless network, said method comprising:
establishing transmission points;
establishing a pilot signal used by mobile communication devices to establish communications with each said transmission point; and
creating from said pilot signal a set of pilot signals with respect to each of said transmission points, each of said pilot signals of said set being differentiated from each other.

17. The method of claim 16 further comprising:
physically directing each of said different pilot codes in a different direction with respect to a transmission point.

18. The method of claim 17 wherein said difference is orthogonal based.

19. The method of claim 17 wherein said difference is achieved by applying different Walsh generated codes to said pilot signal.

20. The method of claim 17 further comprising:
dividing said network into cells and wherein each said cell contains three differentiated pilot signals, said method further comprising:
positioning said pilots in each said cell such that pilot transmissions of a particular pilot code differentiated in a first manner in one cell do not interfere with pilot transmissions of a pilot code differentiated in the same first manner in an adjacent cell.
